(19) United States
(12) Patent Application Publication
(10) Pub. No.: US 2019/0143695 A1
(43) Pub. Date: May 16, 2019

(54) PRINT HEAD MONITORING SYSTEM AND METHOD

(71) Applicant: Hewlett-Packard Development Company, L.P., Houston, TX (US)

(72) Inventors: Sheila Cabello, Sant Cugat del Valles (ES); Diana Canto Estany, Sant Cugat del Valles (ES); Macia Sole, Corvallis, OR (US)

(73) Assignee: Hewlett-Packard Development Company, L.P., Houston, TX (US)

(21) Appl. No.: 16/098,111

(22) PCT Filed: Jul. 19, 2016
(86) PCT No.: PCT/US2016/042989

§ 371 Date: Oct. 31, 2018

(51) Int. Cl. B41J 2/165; B41J 2/145

(52) U.S. Cl. CPC B41J 2/16505; B41J 2/145

(57) ABSTRACT

A print head monitoring system includes a fly-by spitting station, the fly-by spitting station receiving droplet of printing agent from a print head when the print head passes over the fly-by spitting station, and a drop detector which is located at the fly-by spitting station.

### BACKGROUND

For monitoring and improving nozzle health in a printer, such as an inkjet printer or 3D printer, a drop detector can be used to detect nozzles of a print head that are not firing correctly. This process can be automatically or manually triggered at the beginning of a print job, for example. A nozzle replacement strategy can be used to replace nozzles which have been recognized to be faulty by healthy nozzles. Another process is known as fly-by spitting, where extra “spitting”, i.e. ejection of printing agent not used for generating a printout, is performed on the fly when a carriage carrying print heads moves above and past the print zone. A so-called Fly-By Spitting station or spittoon can be provided along a side of the print zone to receive ejected extra printing agent.

### BRIEF DESCRIPTION OF DRAWINGS

For a more complete understanding, various examples will now be described with reference to the accompanying drawings in which:

FIG. 1 shows a schematic diagram of a printer having a print head monitoring system according to one example;

FIG. 2 shows a perspective view of a portion of a printer according to one example;

FIG. 3 shows a flow diagram of a method according to one example; and

FIG. 4 shows a schematic diagram of a printer according to one example.

### DETAILED DESCRIPTION

Examples described herein relate to a print head monitoring system and method and to a printer which can be an inkjet printer or a similar type of printer having a print head ejecting a printing agent from nozzles provided in the print head. If in the following description reference is made to “ink”, the term is to be understood broadly as comprising pigment based and color based inks of any color and other printing agents, including, for example, a fusion agent in a 3-D printer, a medical substance, a conductive substance, a semiconducting substance, a polymer, and any other substance which can be processed by inkjet printing technology. Further, if in the following description, reference is made to a “printer” or to an “inkjet printer”, the term is to be understood broadly as reference to any device using inkjet printing and related technology. This includes, but is not limited to, large format printers. Further, if a certain element is referenced in the singular, such as a print head or a nozzle, this is meant to comprise also the same element in the plural form.

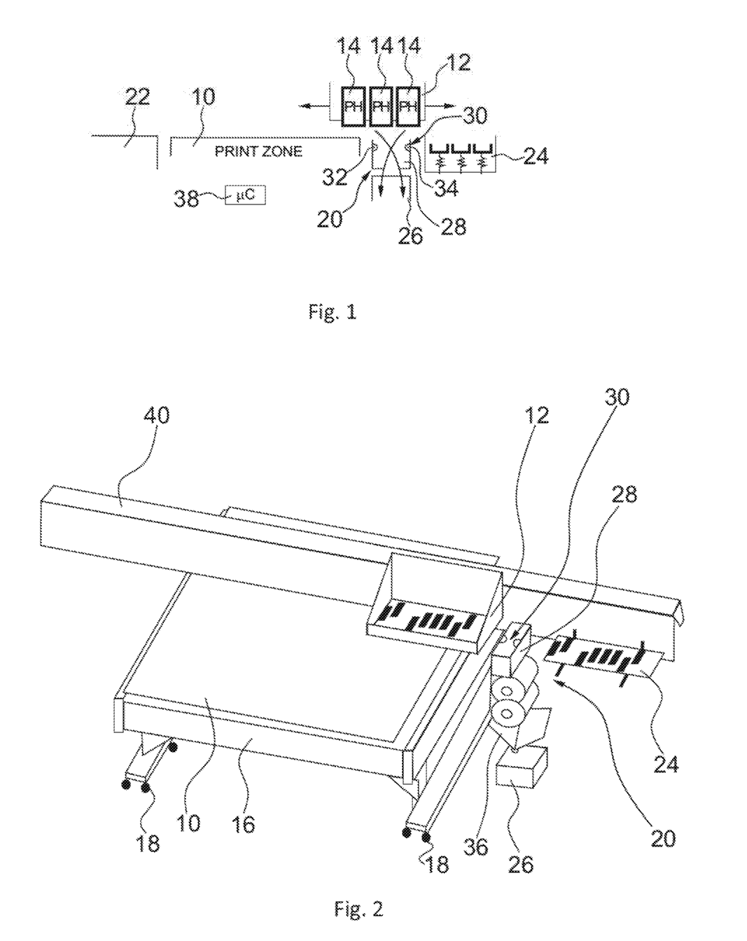

Examples described herein relate to a printer including print heads which can be sup-ported by carriage for movement across a print zone for depositing droplets of ink on a print medium in the print zone. An example of such a printer is schematically shown in FIG. 1.

FIG. 1 schematically shows a print zone 10, and a carriage 12 carrying three print heads 14 across the print zone. A first spitting station 20 is provided on one side of the print zone 10, and a second spitting station 22 is provided on the opposite side of the print zone 10. To better distinguish the two spitting stations, in the following description, spitting station 20 also will be referred to as fly-by spitting station and spitting station 22 also will be referred to as spittoon. Each one of the print heads 14 can fire some or all of its nozzles to eject ink droplets therefrom and to clear the nozzles during the printing process at any one or both of the spitting stations. “Firing of a nozzle” describes a process where a print head nozzle is activated to eject droplets of ink. The fly-by spitting station 20 is provided between the print zone 10 and a capping station 24 where the print heads 14 can be capped and nozzles can be sealed when the printer is not in operation.

When a print head nozzle is not fired for certain amount of time, e.g. 10 seconds or more, there is a risk that the nozzle does not eject an ink droplet along a projected trajectory, e.g. along a straight line, at the first or second firing of the nozzle after the out of use time. This can degrade the image quality of the printout, particularly when printing text and drawings including clearly defined lines. Extended times of non-firing can even lead to a situation where a nozzle is clogged partially or completely. This effect also is referred to as “Decap” which is measured in seconds and depends on the printing agent, the print head architecture and printer environment, such as airflow, heat on the print zone, etc. A Decap time is the time a printer usually can perform intermittent printing without the need for servicing of the print heads. The Decap time can be improved by providing for extra spitting, i.e. firing of print head nozzles, at one or both of the spitting stations 20, 22. In the example depicted in FIG. 1, extra spitting can be performed at the fly-by spitting station 20 when the carriage 12 moves from right to the left (in the direction of the drawing), and at the left hand spittoon 22 when the carriage 12 moves from the left to the right across the print zone 10. The carriage 12 moves the print heads 14 to the side of the print zone 10 over the respective spitting station 20, 22 where the nozzles of the print heads 14 can be fired in selected groups or all nozzles of one print head or even of a plurality of print heads or of all print heads can be fired simultaneously. The ejected ink can be collected in a reservoir 26 associated with the spitting station.

The fly-by spitting station 20 also comprises a drop detector 30 which, in FIG. 1, is schematically represented by a light source 32 and a light receiver 34. A drop detector can comprise an optical system to detect droplets of ink ejected from the print head nozzles and to determine whether all nozzles are firing correctly. The drop detector 30 can detect the presence of a droplet. The drop detector may also identify the volume of a droplet and/or the trajectory of the droplet. Drop detection can be performed at the beginning of a print job. After uncapping the print heads, the carriage can move the print heads over the fly-by spitting station 20 where the nozzles of all of the print heads can be fired in groups or one by one. The drop detector 30 determines whether nozzles are firing correctly, e.g. whether they eject ink droplets as expected and/or whether the volume and/or trajectory of each ink droplet is as expected, and decides which nozzles are acceptable for use in a print job. Nozzles which do not meet a defined criteria or a plurality of defined criteria, e.g. nozzles which do not eject any ink droplet or which eject ink droplet volumes below a defined threshold, are rejected. For rejected nozzles, the printer can recalculate a nozzle firing strategy of the respective print head or group of print heads wherein redundant nozzles can be used to replace the rejected ones.

The printer of FIG. 1 further comprises a control unit, such as a microcontroller 38, for controlling the printing operation, movement of the carriage 12, firing of the print head nozzles for generating the printout and for spitting extra ink at the fly-by spitting station 20 and the spittoon 22, for controlling the drop detector 30 and for calculating a nozzle firing strategy and nozzle replacement strategy, among others. The control unit can be implemented in a single controller, e.g. microcontroller, or it can be distributed over a number of controllers. The above control functions may be implemented in a control unit in the printer, external to the printer, or in a combination thereof, and control signals can be generated internally or externally, in a centralized or distributed environment.

The print architecture illustrated in FIG. 1 is not limited to drop detection at the beginning or end of a print job. Because the drop detector 30 is integrated into the fly-by spitting station 20, nozzle performance can be monitored and evaluated during an ongoing print job. It also is possible to dynamically modify a nozzle replacement strategy during the print job. Extra spitting which is performed at the fly-by spitting station 20 generates ink droplets which go through the drop detector 30. The fly-by spitting station 20, in addition to the reservoir 26, can comprise an entry space 28 in which the drop detector 30 is located. Ink droplets ejected at the fly-by spitting station 20 will go through the entry space 28 and will be detected by the drop detector 30.

In one example, the light source 32 can comprise a number of LEDs which are arranged in an array or row along the length of the fly-by spitting station 20. The entry space 28 together with the array or row of LEDs can extend in the same direction as respective nozzle arrays of the print heads 14. The optical receiver 34 can comprise a corresponding array or row of phototransistors or other light receiving elements. The light source 32 hence can generate a row of light beams, also referred to as light curtain, which are directed at the optical receiver 34. This row of light beams can span the entry space similar to a warp yarn or a single hatching pattern. If one of the light beams is interrupted by an ink droplet or a plurality of light beams are interrupted by a plurality of ink droplets, the drop detector can detect the existence of the ink droplet(s), and properties of the ink droplets, such as their volume and/or trajectory. The drop detector can detect all droplets ejected along the length of each print head 14. If a small number of droplets are ejected at a time, such as two, four, eight, or 16 droplets, depending on the size of the drop detector, accuracy of detection can be improved when compared to trying to detect a larger number of droplets at a time.

Detection of droplets ejected from all nozzles of all of the print heads 14 can be performed sequentially for respective groups of nozzles at the fly-by spitting station 20 wherein each nozzle group is tested on a specific carriage movement. “Testing” of a nozzle may comprise detecting whether the nozzle eject ink, detecting the volume of the ejected droplet and/or detecting the trajectory of the ejected droplet. “Testing” of the nozzle may further comprise comparing the detection result with a threshold or a number of thresholds to decide whether the respective nozzle is failing or healthy. For example, a nozzle may be considered to be healthy if it ejects an ink droplet having an ink volume within a defined range and traveling along a trajectory which deviates by less than a defined angle from a desired trajectory. Once all nozzles of all print heads have been tested, drop detection can start again with the first group of nozzles and continue in sequence with further groups of nozzles until the print job is finished.

The spittoon 22 on the opposite side of the print zone 10 can be used for “normal” fly-by spitting, e.g. by ejecting ink droplets from all nozzles of all print heads all from all nozzles of one of the print heads when the carriage 12 moves the print heads 14 across the spittoon 22 (e.g. which may improve the Decap time). An aerosol extraction device can be integrated into one or both of the spitting stations 20, 22 to collect particles from the ink ejection process.

As the ink ejected at the fly-by spitting station 20 is also used for drop detection, instead of having a separate drop detector, the overall ejection of waste ink, i.e. ink which is not used for generating the printout, can be reduced. Moreover, drop detection can be performed on the fly which allows an adaptive nozzle replacement strategy. This increases image quality robustness, in particular in non-attended printing, such as overnight printing.

FIG. 2 shows a somewhat schematic perspective view of a printer according to one example with some further detail. The same or corresponding components as in FIG. 1 are designated by the same reference numbers. This relates to the print zone 10, the carriage 12, the fly-by spitting station 20 and the capping station 24. The spittoon 22 is not shown in this drawing but can be provided at the opposite side of the print zone 10. As shown in FIG. 2, the print zone 10 can be a flat support table carried by a frame 16 which, in the example depicted in FIG. 2, is carried by rollers 18. The carriage 12 is mounted on a rail 44 for lateral movement along the rail 40 and across the print zone 10. There is a carriage drive and control mechanism which for the sake of clarity is not depicted in FIG. 2. The carriage 12 includes a space for receiving print heads (not shown in FIG. 2) wherein the print heads, at the bottom of the carriage 12, can be fixedly mounted and connected to control circuitry (not shown).

At the side of the print zone 10, aligned with the carriage 12, is a fly-by spitting station 20, comprising an entry space 28 and a reservoir 26. Within the entry space 28 there is a drop detector, schematically shown at 30. The fly-by spitting station 20 also comprises rollers 34 and a funnel 36 for guiding the ink received at the entry space 28 to the reservoir 26. At the side of the fly-by spitting station 20, opposite to the print zone 10, is a capping station 24 including caps for sealing the nozzle plates of the print heads when the printer is not in use.

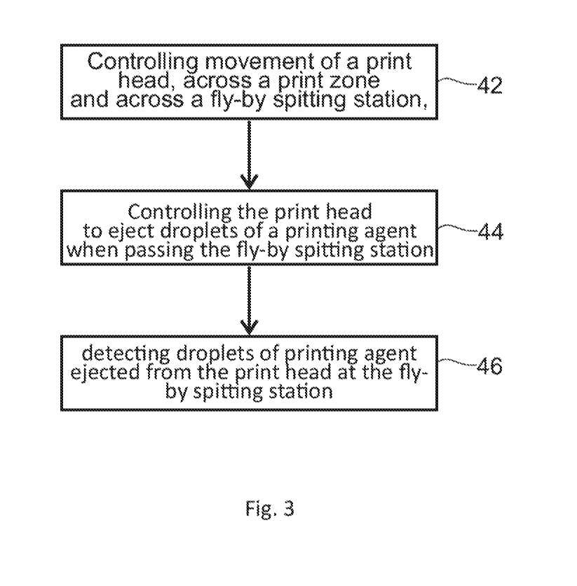

FIG. 3 shows a flow diagram of a printing process according to one example. Whereas drop detection and extra spitting can be performed at the beginning of the print job, after the print heads are uncapped, or during servicing intervals, the case considered with respect to FIG. 3 relates to an ongoing printing process. During the printing process, the carriage 12, carrying at least one print head 14, is controlled to move across the print zone and the print head is controlled to eject ink droplets from the print head nozzles for generating a printout while a print medium is advance through the print zone. In the current example, the print carriage 12, supporting the print head 14, further is controlled to move across the fly-by spitting station 20 at the side of the print zone; see block 40 in FIG. 3. In the further description of this example, reference is made to a single print head; the process can be modified to testing a plurality of print heads, either one after the other or concurrently.

During each pass, or each defined number of passes, the print head is moved beyond the print zone across the fly-by spitting station 20 and, at the beginning of each pass, back across the fly-by spitting station 20 over the print zone 10, in FIG. 1 from right to left. In the current example, if the print head crosses the fly-by spitting station 20 on its way towards the print zone 10, the print head is controlled to eject droplets of the printing agent from a group of its nozzles, wherein the nozzle group comprises less than the total number of nozzles of the print head, see block 42. The group of nozzles may comprise just a small fraction of the total number of nozzles of a print head and will depend, among others, on the speed of print head movement, on the print head architecture and size and on the architecture, size and resolution of the drop detector. For example, for a print head having 128 nozzles arranged in two rows, a group of nozzles may comprise four, eight, or 16 nozzles. For a print head having 2656 nozzles arranged in four rows, a group of nozzles may comprise the same or larger number of nozzles, such as 32 nozzles, just to name a few examples.

The group of nozzles, and the distribution of the nozzles across the nozzle plate of the print head, from which ink is ejected at the fly-by spitting station 20 is selected so that the drop detector 30 can reliably detect the presence of an ink droplet and, if desired, the volume and/or trajectory of the ink droplet; see block 44.

In one example of the printing process, during one pass, e.g. a first pass from right to left, ink is ejected from a first selected group of nozzles of the print head at the fly-by spitting station 20 and the ink droplets are detected by the drop detector 30. In a subsequent pass, in the opposite direction, all of the nozzles of the print head may eject ink at the spittoon 22 located at the opposite side of the print zone 10. In the next pass, in this example a third pass which is again from right to left, a next selected group of nozzles of the print head is fired and the respective ink droplets are detected by the drop detector 30. This process can continue until all nozzles of the print head have ejected ink at least once at the fly-by spitting station 20 for detection by the drop detector 30. Then the sequence can be repeated, by firing and detecting ink droplets from the first selected group of nozzles in a first pass, from the second selected group in a third pass, etc.

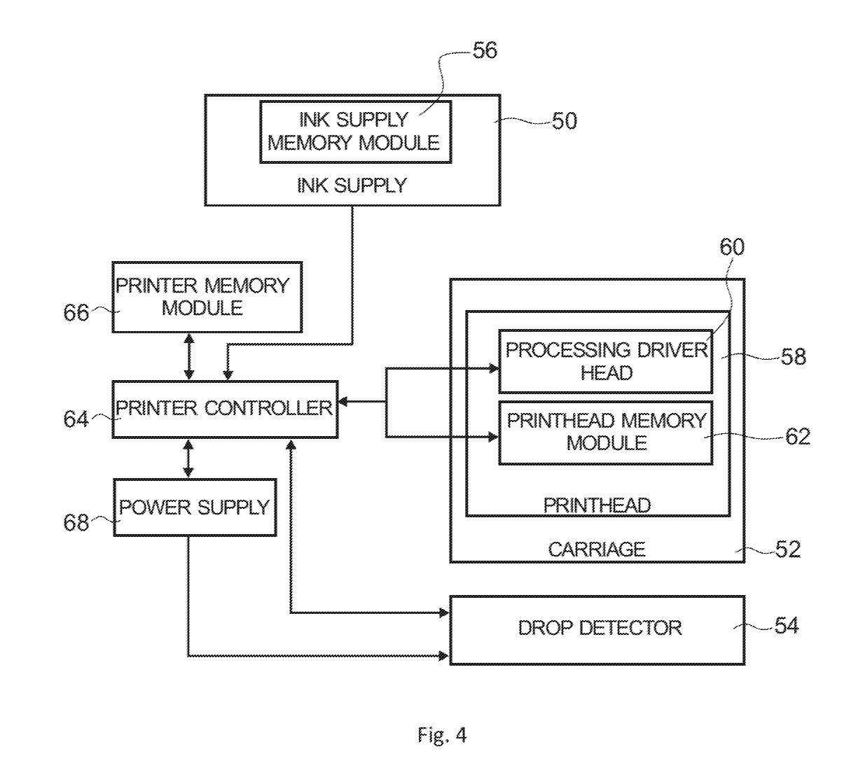

The method described above can be implemented in any type of printer having at least one print head scanning across a print zone. An example of a printer is schematically shown in FIG. 4. The printer of this example is an inkjet printer comprising an ink supply 50, a carriage 52, and a spitting station including an integrated drop detector 55 located at one side of the print zone (not shown in FIG. 4). The ink supply 50 may comprise an ink reservoir and an ink delivery system (not shown in FIG. 4) and an ink supply memory module 56 for monitoring ink supply to a print head or to a number of print heads. A print head 58 is carried by the carriage 52, the print head 58 including nozzles, associated ink propulsion means (not shown) and a print head processing driver 60. Each print head further may comprise a print head memory module 62 for monitoring operation of the print head, storing a table of nozzle states and the like. The printer further comprises a printer controller 64, a printer memory module 66 and a power supply 68. Information from the ink supply 50, the drop detector 54, and the print head 58 is collected at the printer controller 64 to control firing of the nozzles of the print head across the print zone and at the spitting station 54, to determine healthy and failing nozzles of the print head 58 and to control the print head according to a nozzle replacement strategy as needed.

For a printer using a number of print heads, the process described above can be adapted accordingly. For example, the group of nozzles can be distributed over a number of print heads and can include nozzles from different print heads. In another example, nozzles of different print heads can be assigned to different groups and can be tested in different passes by selecting groups of nozzles to comprise nozzles of one and the same print head. In the latter case, the process can be modified to first complete testing all nozzles of one print head before continuing with the next print head. In another example, the process can be modified to test a first nozzle group from a first print head, then continue with a first nozzle group of a second print head, etc. until all nozzles of all print heads have been tested.

Based on the result of the drop detection, failure of at least one nozzles of at least one print head can be detected and any failed nozzle can be replaced by a healthy nozzle according to a dynamic nozzle replacement strategy to continue the print job without interruption. If the total number of failed nozzle increases above a defined threshold or if a defined number of failed nozzles cannot be replaced by respective healthy nozzles according to the nozzle replacement strategy, the printer can issue a warning and can decide to stop the print process. This substantially increases image quality robustness, in particular in non-attended printing, e.g. overnight printing of long rolls of print medium. Banding defects due to missing nozzles can be avoided, without an operator having to check the image quality from time to time. Moreover, the described printer and process can contribute to ink saving because the extra spitting at the fly-by spitting station also is used for drop detection, instead of providing a separate drop detector.

1. A print head monitoring system including a fly-by spitting station, the fly-by spitting station to receive a droplet of printing agent from a print head when the print head passes over the fly-by spitting station, and a drop detector which is located at the fly-by spitting station, to detect the droplet.

2. The system of claim 1, wherein the fly-by spitting station is arranged along one side of a print zone of a printer and comprises a print agent receiving space and the drop detector is arranged at the print agent receiving space.

3. The system of claim 2, wherein the print agent receiving space comprises an entry space and a collecting space, wherein the drop detector is arranged at the entry space and comprises an optical unit to generate a number of light beams through which drops ejected from the print head pass.

4. The system of claim 1 further including
a print head having a number of nozzles and
a control unit,
the control unit including a module for controlling the print head to move across the print zone and the fly-by spitting station, and for causing the print head to fire one of a number of the nozzle groups, when the print head passes over the fly-by spitting station, each of the nozzle groups including less than the total number of nozzles of the print head,
the control unit further including a module for controlling the drop detector to detect drops fired from the nozzle group at the fly-by spitting station.

5. A method of print head monitoring, the method comprising:
controlling movement of a print head, the print head having a number of nozzles, to move the print head across a fly-by spitting station,
controlling the print head to eject droplets of a printing agent from one of a number of groups of the nozzles when the print head passes over the fly-by spitting station, wherein
each of the nozzle groups comprises less than the total number of nozzles of the print head,
detecting the droplets of printing agent ejected from the nozzle group at the fly-by spitting station.

6. The method of claim 5, wherein the droplets of printing agent are detected by a drop detector arranged in the fly-by spitting station.

7. The method of claim 6, wherein, based on the detection result of the drop detector, failure of a nozzle is detected and the failed nozzle is replaced by another nozzle to perform a print job without interrupting the print job.

8. The method of claim 5, wherein the fly-by spitting station is arranged along a side of a print zone, and the print head is controlled to move across the print zone and the fly-by spitting station, wherein, in subsequent passes across the fly-by spitting station, different ones of the nozzle groups of the print head are controlled to eject droplets of printing agent to be detected.

9. The method of claim 8, wherein a fly-by spittoon is arranged along an opposite side of the print zone, wherein the print head is controlled to move across the print zone, the fly-by spitting station, and the fly-by spittoon, wherein, in passes across the fly-by spittoon, all nozzles of the print head eject droplets of printing agent.

10. The method of claim 8, wherein, in a sequence of passes across the fly-by spitting station, respective ones of the nozzle groups of the print head are controlled to eject droplets of printing agent to be detected in a sequence, until each one of the nozzle groups of the print head has ejected droplets of printing agent to be detected.

11. The method of claim 10, wherein, after each one of the nozzle groups of the print head has ejected droplets of printing agent to be detected, respective ones of the nozzle groups of the print head are controlled to eject droplets of printing agent to be detected in a next sequence.

12. The method of claim 5, wherein a plurality of print heads is provided and, and one of the nozzle groups is defined to comprise nozzles from one print head of the plurality of print heads or from at least two print heads of the plurality of print heads.

13. A printer including
a print zone,
a fly-by spitting station arranged along one side of the print zone,
a drop detector arranged in the fly-by spitting station, and
a print head carriage arranged to scan across the print zone and the fly-by spitting station.

14. The printer of claim 13, further including a fly-by spittoon arranged along a side of the print zone opposite to the fly-by spitting station, the fly-by spittoon not to comprising a drop detector.

15. The printer of claim 13, further including an aerosol extraction device associated with the fly-by spitting station.
